(19) United States
(12) Patent Application Publication
(10) Pub. No.: US 2009/0084236 A1
(43) Pub. Date: Apr. 2, 2009

(54) PUNCHING SYSTEM USING PUNCHING MACHINE

(75) Inventors: SHENG WU, Shenzhen City (CN); JIN-SHAN CUI, Shenzhen City (CN); SAN-YAN ZHANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: SHENZHEN FUTAIHONG PRECISION INDUSTRY CO., LTD., ShenZhen City (CN); FIH (HONG KONG) LIMITED, Kowloon (HK)

(21) Appl. No.: 12/164,241

(22) Filed: Jun. 30, 2008

(30) Foreign Application Priority Data
Sep. 28, 2007 (CN) 200710201883.2

(51) Int. Cl. B26D 7/18; B26D 7/06

(52) U.S. Cl. 83/98; 83/102; 83/365; 83/368

(57) ABSTRACT

A punching system (100) for punching preliminary workpieces into products and scraps is provided. The punching system includes a feeding device (10), a punching machine (20), a selecting device (40), and an electric control subsystem (50). The feeding device is configured for feeding the preliminary workpieces. The punching machine is configured for receiving the preliminary workpieces fed from the feeding device and punching the preliminary workpieces into the products and the scraps. The selecting device is configured for separately selecting and transporting the products to a corresponding working station and the scraps to a corresponding scrap station. The electric control subsystem electrically connects with the feeding device, the punching machine, and the selecting device, and is configured for controlling the respective operation of the feeding device, the punching machine, and the selecting device.

### BACKGROUND

1. Field of the Invention

The present invention relates to punching systems, particularly to a punching system using a punching machine.

2. Description of related art

Punching machines typically have a continuous mold assembled therewith. Thus, the machining performance of the punching machine is largely enhanced by the operation of the continuous mold. However, use of the continuous mold produces scraps as well as the desired product during manufacturing. The products mixed with the scraps are transported by a belt to a next workstation where the products are manually separated from the scraps. The need for manual labor to separate out the scrap is time consuming and expensive. Additionally, there is a risk that the scrap materials may damage the products while they are mixed together.

Therefore, a need exists in the art to address the above deficiencies and inadequacies.

### BRIEF DESCRIPTION OF THE DRAWINGS

Many aspects of the present punching system using a punching machine can be better understood with reference to the following drawings. These drawings are not necessarily drawn to scale, the emphasis instead being placed upon clearly illustrating the principles of the present punching system using the punching machine. Moreover, in the drawings like reference numerals designate corresponding parts throughout the several views. Wherever possible, the same reference numbers are used throughout the drawings to refer to the same or like elements of an embodiment.

FIG. 1 is a block diagram of a punching system according to an exemplary embodiment, the punching system including a feeding device, a punching machine, a selecting device, and an electric control subsystem.

FIG. 2 is a planar view of the punching system shown in FIG. 1, not showing the feeding device and the electric control subsystem shown in FIG. 1.

FIG. 3 is an isometric view of the punching system shown in FIG. 2.

FIG. 4 is an enlarged view of a circled portion IV of the punching system shown in FIG. 3.

FIG. 5 is an isometric view of the punching system shown in FIG. 3, illustrating a working status thereof as a pressing board is pressed in contact with a lower board.

FIG. 6 is an isometric view of the punching system shown in FIG. 3, illustrating another working status thereof with the pressing board stopped and the upper mold moved further towards the lower board.

FIG. 7 is an isometric view of the punching system shown in FIG. 3, illustrating another working status thereof with the pressing board having been driven away from the lower mold.

FIG. 8 is an enlarged partial view of a circled portion VIII of the punching system shown in FIG. 7.

### DETAILED DESCRIPTION OF THE EMBODIMENTS

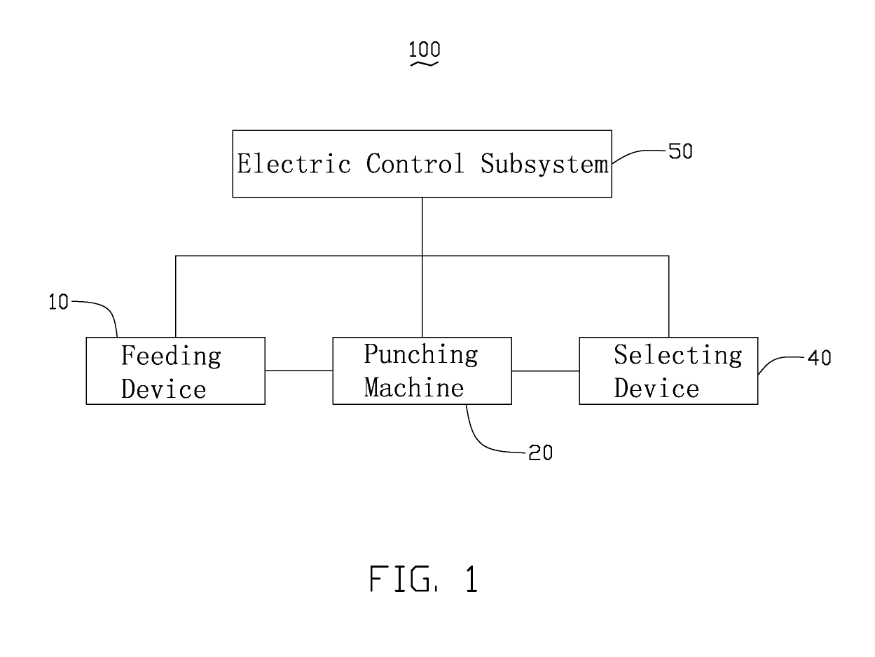

The present punching system using a punching machine is described here in conjunction with the accompanying drawings in FIGS. 1 through 8.

Referring to FIGS. 1 through 4, the punching system 100 includes a typical feeding device 10, a punching machine 20, a selecting device 40, and an electric control subsystem 50. With regard to the working of the punching system 100, the feeding device 10, the punching machine 20, and the selecting device 40 are connected together in that order. The electric control subsystem 50 electrically connects with the feeding device 10, the punching machine 20, and the selecting device 40, and controls their operations.

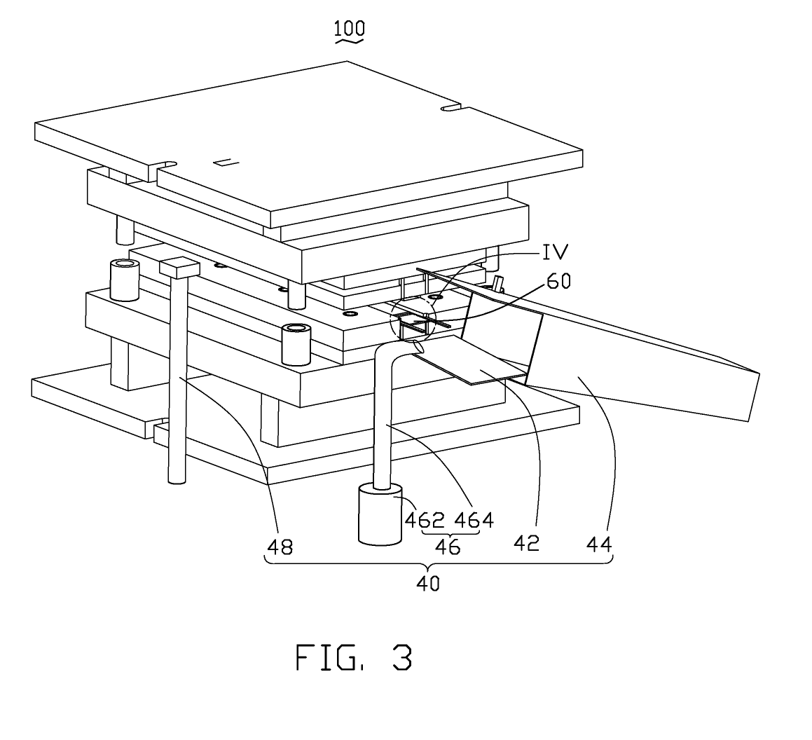

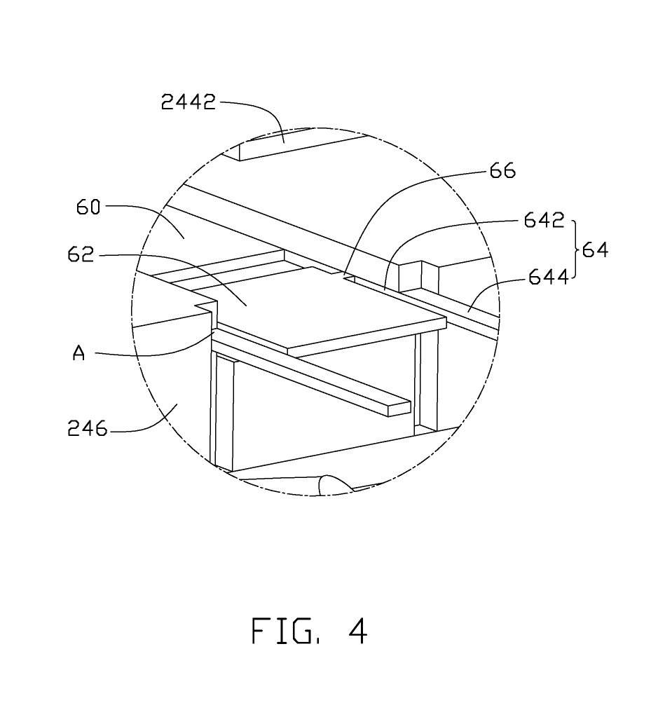

The feeding device 10 feeds preliminary workpieces (e.g., metal boards or metal belts) into the punching machine 20. In this exemplary embodiment, a metal belt 60 (FIGS. 3 and 4) is provided as a preliminary workpiece to be punched by the punching machine 20. The metal belt 60 includes a product 62, two scrap belts 64, and two connecting portions 66. Each connecting portion 66 connects one of the two scrap belts 64 with the product 62.

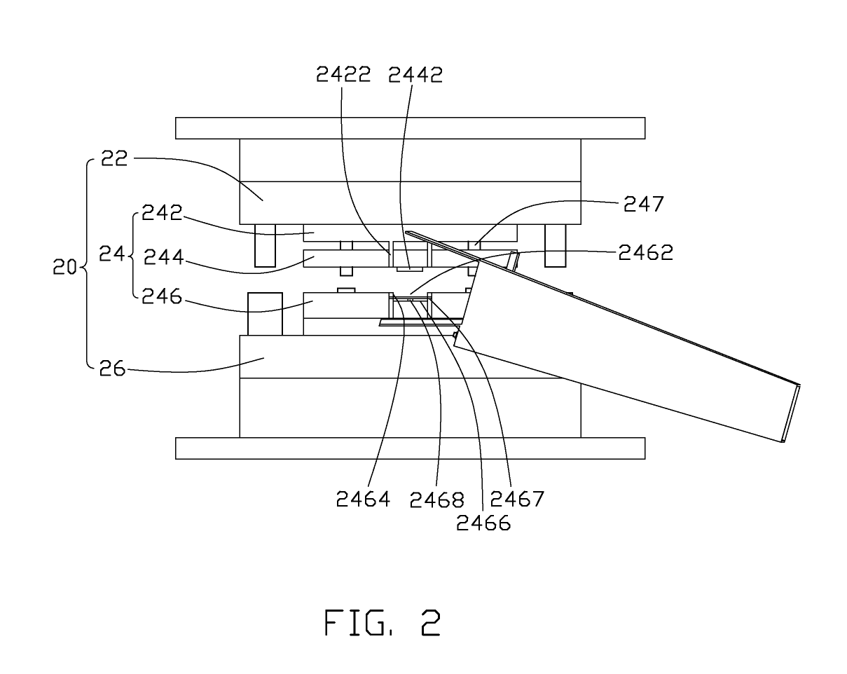

Referring to FIG. 2, the punching machine 20 includes an upper fixing board 22, a continuous mold 24, and a lower fixing board 26. The continuous mold 24 includes an upper mold 242, a pressing board 244, and a lower mold 246. The upper mold 242 is securely fixed to the upper fixing board 22. The pressing board 244 is positioned beneath the upper mold 242 and firmly attached to the upper mold 242 using a plurality of guiding columns 247. The lower mold 246 is securely fixed to the lower fixing board 26 and located below and to the right of the pressing board 244.

The upper mold 242 has two first punching portions (not shown) and two second punching portions 2422, all of which face the pressing board 244. Each first punching portion corresponds with one of the two connecting portions 66 and are configured for cutting the connecting portion 66 so the product 62 is disconnected from the two scrap belts 64. Each second punching portions 2422 is located to correspond with a labeled position A of each scrap belt 64 and configured for cutting the scrap belts 64 into a first scrap belt section 642 and a second scrap belt section 644. The first scrap belt section 642 is the remainder of the scrap belt 64 after the cut. The second scrap belt section 642 is the cut section after the cut.

The pressing board 244 has substantially the same size and shape as that of the upper mold 242. The pressing board 244 has a protruding stage 2442 protruding towards the lower mold 246. The protruding stage 2442 is located to correspond with the product 62 of the metal belt 60 and configured for holding the product 62.

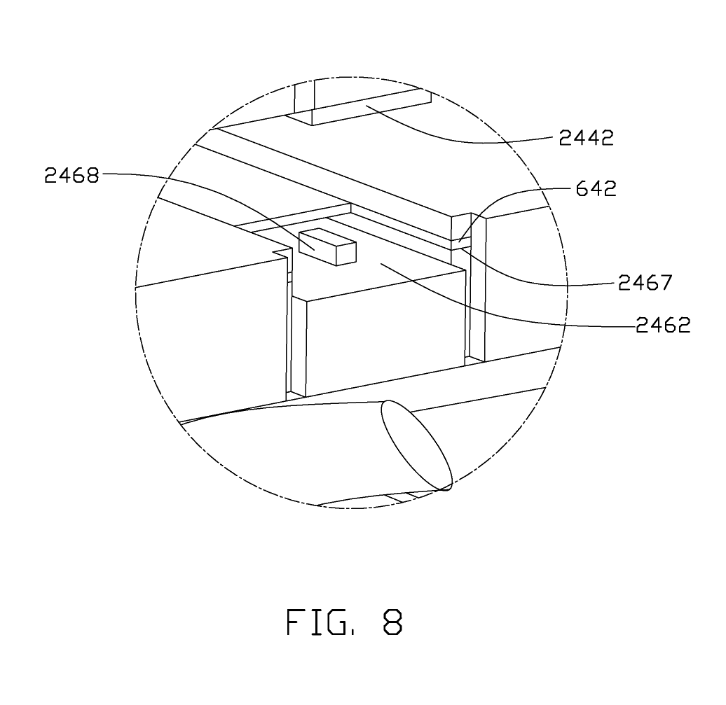

Referring further to FIG. 8, the lower mold 246 defines a recess 2462 exposed to the pressing board 244. The recess 2462 is enclosed by two opposite recess sidewalls 2464 and a recess bottom wall 2466. Each recess sidewall 2464 has a guiding recess 2467 defined therein. The guiding recess 2467 has a cross section (not labeled) substantially same shape and size as the scrap belts 64. The scrap belts 64 are accommodated and guided by the guiding recess 2467.

The recess bottom wall 2466 has a supporting protrusion 2468 formed thereon, which corresponds with the product 62 and is configured for supporting the product 62.

Referring back to FIG. 3, the selecting device 40 is configured for sorting/separating the product 62 and the second scrap belt sections 644 for the corresponding workstation and scrap station. The product 62 and the second scrap belt sections 644 are cut from the metal belt 60. The selecting device 40 includes a first transporting portion 42, a second transporting portion 44, an air impelling portion 46, and a photoelectric sensor 48.

The first transporting portion 42 has one end connected with the punching machine 20 and the other end connected with a next working station (not shown). The first transporting portion 42 collects the product 62 cut from the metal belt 60 and transports the product 62 to the next workstation. The second transporting portion 44 is near the first transporting portion 42 collects the second scrap belt section 644 cut from the metal belt 60 and transports the second scrap belt section 644 to a scrap station (not shown).

The air impelling portion 46, linked to the electric control subsystem 50, impels air from an air supply 461 through an air pipe 462 to blow the second scrap belt section 644 towards the second transporting portion 44. The air pipe 462 has one end securely attached at one side of the first transporting portion 42 and located opposite to the second transporting portion 44.

The photoelectric sensor 48 is also linked to the electric control subsystem 50, and is positioned to one side of the punching machine 20 for sensing and measuring the moving distance of the pressing board 244. If the pressing board 244 is pressed into contact with the lower mold 246, the photoelectric sensor 48 transmits a starting signal to the electric control subsystem 50. The electric control subsystem 50 signals the air impelling portion 46 to blow air towards the second transporting portion 44. The air impelling action of the impelling portion 46 is stopped by the electric control subsystem 50 when the pressing board 244 is driven away from the lower mold 246, causing a stop signal to be sent from the photoelectric sensor 48 to the electric control subsystem 50.

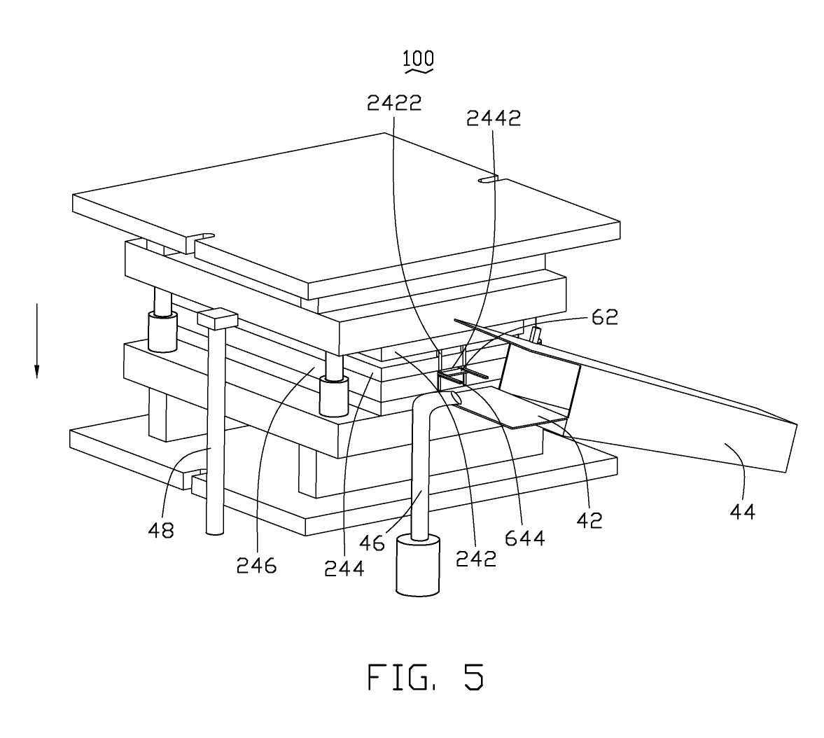

When using the punching system 100, the feeding device 10 feeds the metal belt 60 into the punching machine 20. Referring further to FIG. 5, the second scrap belt section 644 of the metal belt 60 hangs down from punching machine 20, above the first transporting portion 42. Accordingly, the product 62 is supported by the supporting protrusion 2468. The product 62 is partially hung above the first transporting portion 42. Thus, as each connecting portion 66 is cut by one of the first punching portions, the product 62 falls onto the first transporting portion 42.

As punching machine 20 works, the upper mold 242 and the pressing board 244 move towards the lower mold 246 along a direction indicated by an arrow shown in FIG. 5. The upper mold 242 and the pressing board 244 move until the pressing board 244 is pressed into contact with the lower mold 246. Then, the protruding stage 2442 and the supporting protrusion 2468 hold the product 62 between them. Simultaneously, the photoelectric sensor 48 senses the moving distance of the pressing board 244 and transmits a starting signal to the electric control subsystem 50. Then, the electric control subsystem 50 controls the air impelling portion 46 of the selecting device 40 to impel air towards the second transporting portion 44 of the selecting device 40.

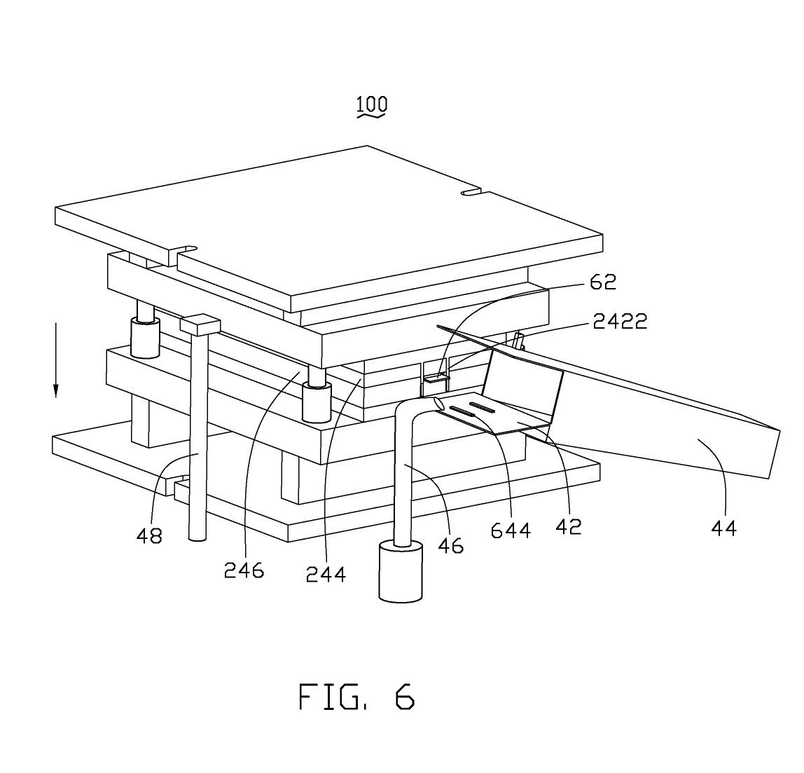

Referring further to FIG. 6, the pressing board 244 is stopped and held. The upper mold 242 moves further along a direction indicated by an arrow shown in FIG. 6. The movement of the upper mold 242 drives the two first punching portions. Each of the first two punching portions cut one of the two connecting portions 66, and simultaneously drives the second punching portions 2422 to cut the scrap belt 64 into the first scrap belt section 642 and the second scrap belt section 644. Thus, the product 62 is disconnected from the two scrap belts 64.

At this point, because the second scrap belt section 644 is hanging above the first transporting portion 42, the second scrap belt section 644 directly falls down onto the first transporting portion 42 and is then blown onto the second transporting portion 44 of the selecting device 40. The second transporting portion 44 transports the second scrap belt section 644 to the scrap station. The protruding stage 2442 of the pressing board 244 and the supporting protrusion 2468 of the lower mold 246 hold the cut product 62 between them.

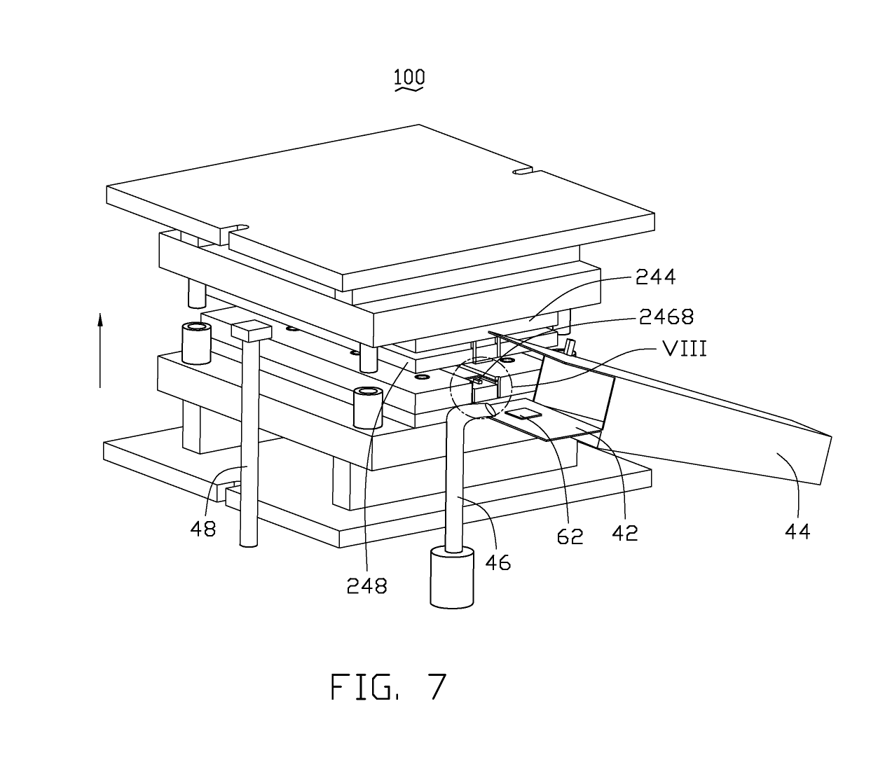

Referring further to FIGS. 7 and 8, the pressing board 244 and the upper mold 242 moves away from the lower mold 246 along a direction indicated by an arrow line shown in FIG. 7. The photoelectric sensor 48 senses the movement and sends a stop signal to the electric control subsystem 50. The electric control subsystem 50 receives the stop signal and stops the air impelling action of the impelling portion 46. The cut product 62 being held by the protruding stage 2442 and the supporting protrusion 2468 is released, and falls onto the first transporting portion 42. Then, the product 62 is transported to the next workstation.

It is to be understood, however, that even through numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A punching system for punching preliminary workpieces into products and scraps, comprising:
a feeding device configured for feeding the preliminary workpieces;
a punching machine configured for receiving the preliminary workpieces fed from the feeding device and punching the preliminary workpieces into the products and the scraps;
a selecting device configured for separately selecting and transporting the products to a working station and the scraps to a scrap station; and
an electric control subsystem linking the feeding device, the punching machine, and the selecting device, and the electric control subsystem being configured for controlling the operations of the feeding device, the punching machine, and the selecting device.

2. The punching system as claimed in claim 1, wherein:
the selecting device comprises a first transporting portion, a second transporting portion, an air impelling portion, and a photoelectric sensor, such that;
the first transporting portion being configured for collecting and transporting the products punched from the punching machine to the working station;
the second transporting portion being configured for collecting and transporting the scraps punched from the punching machine to the scrap station;
the air impelling portion being controlled by the electric control subsystem and configured for blowing the scraps to the second transporting portion; and
the photoelectric sensor being configured for sensing and measuring punching operations and transmitting a starting signal or a stop signal into the electric control subsystem to control the air impelling portion.

3. The punching system as claimed in claim 2, wherein the first transporting portion has one end connected with the punching machine, the second transporting portion being near the first transporting portion.

4. The punching system as claimed in claim 3, wherein the air impelling portion comprises an air supply and an air pipe, the air pipe communicating with the air supply and having one end securely attached at one side of the first transporting portion and located opposite to the second transporting portion.

5. The punching system as claimed in claim 2, wherein:
the punching machine comprises an upper fixing board, a continuous mold, and a lower fixing board; and
the continuous mold comprising an upper mold, a pressing board, and a lower mold, the pressing board positioned beneath and firmly attached to the upper mold, the lower mold being securely fixed to the lower fixing board and located rightly below the pressing board.

6. The punching system as claimed in claim 5, wherein the photoelectric sensor is assembled on one side of the punching machine for sensing and measuring moving distance of the pressing board.

7. The punching system as claimed in claim 6, wherein if the pressing board is pressed into contact with the lower mold, the photoelectric sensor transmits the starting signal to the electric control subsystem, the electric control subsystem signaling the air impelling portion to impel air towards the second transporting portion.

8. The punching system as claimed in claim 7, wherein the pressing board has a protruding stage protruding towards the lower mold, the lower mold having a supporting protrusion formed thereon, the protruding stage corresponding with the supporting protrusion, and the protruding stage combined with the supporting protrusion being configured for holding the products each therebetween.

9. A punching system for punching preliminary workpieces into products and scraps, comprising:
a feeding device;
a punching machine physically connecting with the feeding device;
a selecting device assembled with the punching machine; and
an electric control subsystem linking the feeding device, the punching machine, and the selecting device;
wherein the preliminary workpieces are fed by the feeding device to the punching machine, and then punched by the punching machine into product and scrap, the product is selected by the selecting device and transported to a work station, the scrap is selected by the selecting device and transported to a scrap station, the operations on the preliminary workpieces, the products, and the scraps are controlled by the electric control subsystem

10. The punching system as claimed in claim 9, wherein:
the selecting device comprises a first transporting portion, a second transporting portion, an air impelling portion, and a photoelectric sensor; and
the first transporting portion being configured for collecting and transporting the products punched from the punching machine to the working station;
the second transporting portion being configured for collecting and transporting the scraps punched from the punching machine to the scrap station;
the air impelling portion being controlled by the electric control subsystem and configured for blowing the scraps to the second transporting portion; and
the photoelectric sensor being configured for sensing and measuring punching operations and transmitting a starting signal or a stop signal into the electric control subsystem to control the air impelling portion.

11. The punching system as claimed in claim 10, wherein the first transporting portion has one end connected with the punching machine, the second transporting portion being near the first transporting portion.

12. The punching system as claimed in claim 1, wherein the air impelling portion comprises an air supply and an air pipe, the air pipe communicating with the air supply and having one end securely attached at one side of the first transporting portion and located opposite to the second transporting portion.

13. The punching system as claimed in claim 12, wherein the punching machine comprises:
an upper fixing board, a continuous mold, and a lower fixing board, wherein:
the continuous mold comprising an upper mold, a pressing board, and a lower mold, the pressing board being positioned beneath and firmly attached to the upper mold, the lower mold being securely fixed to the lower fixing board and located below the pressing board.

14. The punching system as claimed in claim 13, wherein the photoelectric sensor is assembled on one side of the punching machine for sensing and measuring moving distance of the pressing board.

15. The punching system as claimed in claim 14, wherein if the pressing board is pressed into contact with the lower mold, the photoelectric sensor transmits a control signal to the electric control subsystem, the electric control subsystem signaling the air impelling portion to impel air towards the second transporting portion.

16. The punching system as claimed in claim 15, wherein the pressing board has a protruding stage protruding towards the lower mold, the lower mold having a supporting protrusion formed thereon, the protruding stage corresponding with the supporting protrusion, and the protruding stage combined with the supporting protrusion being configured for holding the products each therebetween.
